(19) United States
(12) Patent Application Publication
(10) Pub. No.: US 2009/0213417 A1
(43) Pub. Date: Aug. 27, 2009

(54) IMAGE FORMING APPARATUS

(75) Inventor: Kaoru Ishikura, Kyoto (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/365,324

(22) Filed: Feb. 4, 2009

(30) Foreign Application Priority Data
Feb. 21, 2008 (JP) 2008-039521

(51) Int. Cl. G06F 3/12

(52) U.S. Cl. 358/1.15

(57) ABSTRACT

An image forming apparatus that prevents fraudulent alteration of the working life of a replaceable unit is provided. The unit includes a first memory that can store the consumed amount of the unit, and a second memory that has a plurality of flags. “OFF” of each of the flags is not changeable to “ON”. The image forming apparatus includes a portion that counts upward a stored value of the first memory associated with use of the unit and the portion initializes the first memory when the stored value of the first memory exceeds the maximal value. The portion changes the state of any one flag in “ON” of the second memory to “OFF”. The image forming apparatus also includes a portion that judges the working life of the unit based on the stored value of the second memory and the portion signals the working life.

This Non-provisional application claims priority under 35 U.S.C. §119(a) on Patent Application No. 2008-039521 filed in JAPAN on Feb. 21, 2008, the entire contents of which are hereby incorporated herein by reference.

### FIELD OF THE INVENTION

The present invention relates generally to an image forming apparatus, and, more specifically, to a technique of preventing falsification of the life of replaceable consumables that are used in the image forming apparatus.

### BACKGROUND OF THE INVENTION

For example, the toner amount obtained by subtracting the consumed amount from the toner amount that is initially set is stored in a volatile memory as the current amount of toner in a replaceable cartridge. Therefore, a life of the cartridge could be intentionally extended by rewriting the content of the volatile memory.

Therefore, a monitoring system of Japanese Patent Publication No. 2563160 includes a first memory (EEPROM) and a second memory (PROM) in a replaceable cartridge. The first memory stores the current amount in the cartridge (for example, the number of paper sheets that are printable or the amount of remaining toner). The second memory includes a plurality of flags, and the state of each of the flags can be changed from a first state (1) to a second state (0). However, the state of each of the flags can not be changed from the second state (0) to the first state (1).

In the monitoring system, the maximal amount that is the amount corresponding to the life of the cartridge is first set in the first memory and each consumed amount is subtracted from the amount in the first memory, and the state of one of the flags in the second memory is changed from the first state (1) to the second state (0) for each predetermined interval value (for example, 128, 256, 512, or 1024).

In the monitoring system, when the power of a printer is turned on or when the cartridge is attached to the printer, if the content of the first memory is larger than a value obtained by multiplying the number of flags of the first state (1) by the interval value, the life of the cartridge is considered to have been falsified.

However, a falsification preventiving measure is taken in the monitoring system of the above '160 publication. However, the first memory and the second memory are not separately managed. Therefore, whether the life of the cartridge is falsified (modified) is checked when the power of the printer is turned on or when the cartridge is attached to the printer, and when the life is falsified, processing for writing the accumulated consumed amounts calculated from the second memory into the first memory is executed.

In the monitoring system of the above '160 publication, a memory capacity (the number of bits) enough to express the life of the cartridge is necessary for each of the first and the second memories, and therefore, this causes an increase in cost of the cartridge.

### SUMMARY OF THE INVENTION

The object of the present invention is to provide an image forming apparatus that prevents falsification of a life of a replaceable unit using memories each having a small capacity included in the unit.

The image forming apparatus of the present invention forms an image using a unit attached thereto and detects the working life of the unit attached thereto, wherein the unit comprises: a first memory that has a data width capable of storing the consumed amount of the unit; and a second memory that has a plurality of flags and each of the flags is capable of representing one of a first state and a second state and the first state can be changed to the second state while the second state can not be changed to the first state, and wherein the image forming apparatus comprises: a state changing portion that counts up a stored value of the first memory according to the use of the unit, and initializes the first memory and changes the state of any of the flags in the first state of the second memory to the second state when the stored value of the first memory exceeds a maximal value; and a signaling portion that determines and signals the working life of the unit based on the stored value of the second memory.

A toner cartridge or a printing paper sheet supply cassette is applied as the unit. The toner supply amount to a developing apparatus or the number of printed paper sheet is used as the data that increases the value of the first memory.

### BRIEF DESCRIPTION OF THE DRAWINGS

FIG. 1 is a block diagram of the schematic configuration of an image forming apparatus according to an embodiment;

FIG. 2 is a diagram of the configuration of memories included in a consumables unit according to the embodiment; and

FIG. 3 is a flowchart of a process procedure of a control portion according to the embodiment.

### PREFERRED EMBODIMENT OF THE INVENTION

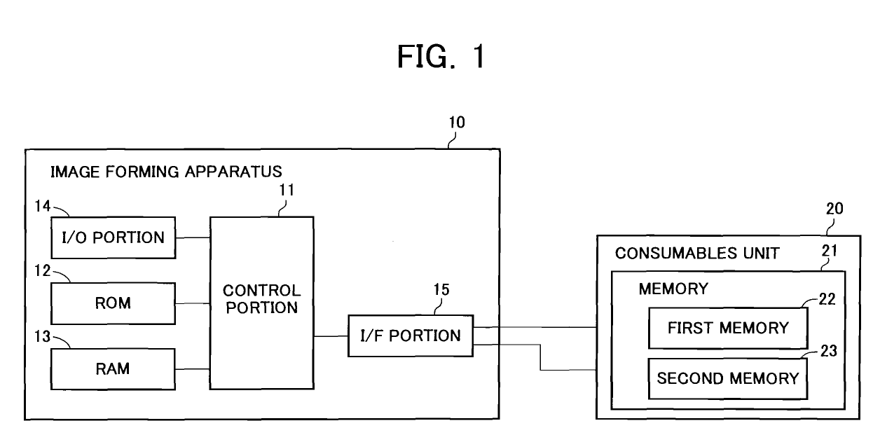

A preferred embodiment according to an image forming apparatus of the present invention will be described referring to the accompanying drawings. FIG. 1 is a block diagram of the schematic configuration of an image forming apparatus of the present invention. In FIG. 1, an image forming apparatus 10 includes a plurality of control portions and a specific control portion 11 manages attaching and detaching of a consumables unit 20 and the current amount in the consumables unit 20.

The consumables unit applied to the present invention is a unit such as a photo-sensitive unit or a transfer unit, that needs replacement or replenishment according to the remaining amount (current amount) of consumables, the operating time, and the number of times of operation, etc. A toner cartridge will be taken as an example in the following description.

The control portion 11 includes a ROM (Read Only Memory) 12 to store a program for controlling the operation of the image forming apparatus main body, a RAM (Random Access Memory) 13 to temporarily store data, an I/O (input and output) portion 14 for the control portion 11 to control the operation of the apparatus, and an I/F (InterFace) portion 15 to execute communication with the consumables unit 20.

The control portion 11 executes reading control and writing control of a memory 21 included in the consumables unit 20 through the I/F portion 15.

The control portion 11 knows the toner amount in a developing tank and the toner amount in the consumables unit (toner cartridge) 20 of the image forming apparatus 10 and, when the toner amount in the developing tank reaches an amount equal or less than the predetermined amount, the toner in the developing tank is maintained at a constant amount as being supplied from the consumables unit (toner cartridge) 20.

The memory 21 of the consumables unit (toner cartridge) 20 provides a memory that can be addressed to store or record the current amount of the consumables to manage the life of the consumables unit 20. The current amount is updated when the image forming apparatus 10 is operated.

The memory 21 is composed of a first memory 22 and a second memory 23, and expresses the current amount of the consumables (toner) in the consumables unit 20.

The first memory 22 is composed of a rewritable nonvolatile memory, for example, an EEPROM (Electrically Erasable and Programmable Read Only Memory). A stored value of the first memory 22 is adapted to increase for each one unit of toner supply time from zero.

In the above, one unit of toner supply time refers to a time interval to count and this unit is set in advance. The time interval is an arbitrary value. For example, when one unit is four seconds, the stored value of the first memory 22 is increased for every four-second of the toner supply time.

The secondmemory 23 is composed of a plurality of flags that are non-volatile memories. Though the state of each of the flags can be changed from a first state to a second state, the state can not be changed from the second state to the first state. The second memory 23 is composed of, for example, a PROM (Programmable Read Only Memory).

When the stored value of the first memory 22 exceeds the maximal number that the first memory 22 can express, any of the flags of the second memory 23 is changed from the first state to the second state. At this time, the stored value of the first memory 22 is set to zero.

The current amount of toner can be calculated according to the following equation based on the above stored values of the first and the second memories.

(Current amount)=(the number of flags in the first state of the second memory 23)×(1+the maximal number that the first memory 22 can express)−(the stored value of the first memory 22)

In the embodiment, the working life of the consumables unit (toner cartridge) 20 is expressed as the time that is measured in second to supply all the toners in the consumables unit (toner cartridge) 20 into the developing tank of the image forming apparatus 10 when one unit of the toner supply time is one second.

When the working life of the toner cartridge is assumed to be 16,320 seconds and the number of flags of the second memory 23 is 64, the maximal number that the first memory 22 can express is 16,320÷64=255.

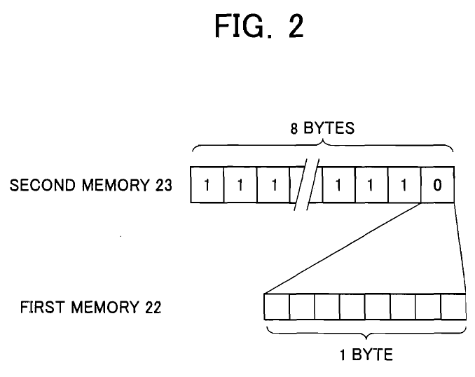

Therefore, in the embodiment, as exemplified in FIG. 2, the memory 21 that is composed of the first memory 22 of one byte (eight bits) and the second memory 23 of eight byte bits) is necessary. Zero is set for the stored value of the first memory 22 and the first state (1) is set to each of all the flags of the second memory 23 as the initial values.

The stored value of the first memory 22 is increased by one for each one unit of the toner supply time when toner is supplied from the consumables unit (toner cartridge) to the developing tank. When the stored value of the first memory 22 exceeds the maximal value that the first memory 22 can express, any one flag (one bit) of the second memory 23 that is the first state is rewritten to the second state (0) and zero is set in the first memory 22.

The data width of the memory 21 is not limited to the above embodiment.

For example, the number of flags of the second memory 23 and the data width of the first memory 22 (which determines the expressible maximal number) are determined to satisfy the following equation and the maximal number that the first memory 22 can express is taken as small as possible when “the working life of the toner cartridge” is measured in a unit of toner supply time.

(Working life of the toner cartridge)=(the number of flags of the first state of the second memory 23)×(1+the maximal number that the first memory 22 can express)

However, when the number of flags of the second memory 23 is determined in advance and is more than the number of flags that express the working life of the toner cartridge, zero is set to each of the excessive flags.

Thereby, the data width of the second memory 23 included in the toner cartridge can be standardized.

By determining the maximal number that the first memory 22 can express as (the powers of two−1), “the judgment of the time when the stored value of the first memory 22 exceeds the maximal value” can be replaced with “the judgment of whether overflow occurs”. Thereby, an increasing circuit of the memory 21 can be simplified.

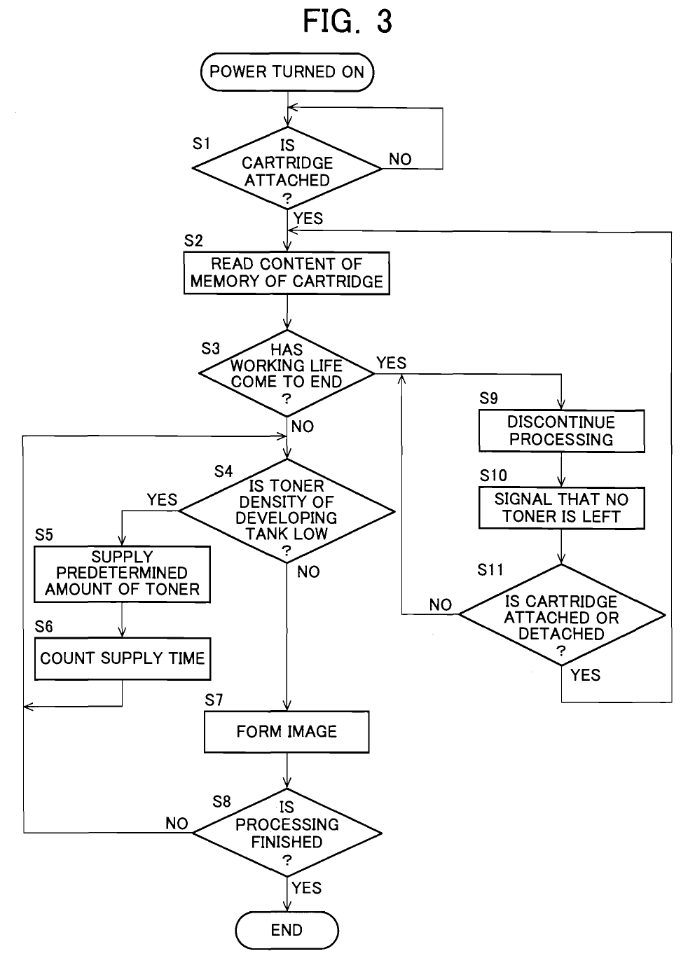

Referring to a flowchart of FIG. 3, a process procedure of the control portion 11 according to the embodiment will be described.

When a user starts up the image forming apparatus, an initializing subroutine stored in the ROM 12 operates and checks whether the consumables unit (toner cartridge) 20 is attached (step S1)

When the consumable unit (toner cartridge) is attached (step S1/YES), the contents of the first memory 22 and the second memory 23 of the consumables unit 20 are laid out on the RAM 13 (step S2).

Whether the working life of the consumables unit 20 comes to an end is checked from the content of the second memory 23 (step S3). When all the flags of the second memory 23 laid out on the RAM 13 are in the second state (0), it is judged that the working life of the consumables unit 20 comes to an end.

When the working life of the consumables unit 20 comes to an end (step S3/YES), the printing operation is discontinued (step S9) and a message stating “Replace the toner cartridge because the toner has run out.” is displayed on an operation panel (step S10). The operation of the image forming apparatus 10 is discontinued until the consumables unit (toner cartridge) is replaced (steps S9 to S11/NO).

On the other hand, when the working life of the consumables unit 20 does not come to an end (step S3/NO), the image forming apparatus enters stand-by state and becomes in the state capable of printing.

When a print request occurs, the image forming apparatus 10 operates and starts to print.

At this time, the toner density is detected using a toner density sensor in the developing tank. When the toner density is lower than the predetermined threshold value (step S4/YES), a toner motor is rotated to supply toner from the consumables unit (toner cartridge) 20 to the developing tank (step S5). During the supply of the toner, the toner supply time is measured using an internal timer. The stored value of the first memory 22 is increased and the renewed stored value is written into the first memory 22 of the consumables unit (toner cartridge) 20 (step S6) for every one second that is spent for supplying toner (one unit of the toner supply time), and the procedure returns to step S4.

When the stored value of the first memory 22 exceeds the maximal value that the first memory 22 can express (in this example, one is added to 256), a flag of the second memory 23 in the first state (1) is found and the first state (1) thereof is changed to the second state (0), and further the stored value of the first memory 22 is changed to zero, and the zero is written into the first memory 22 of the consumables unit (toner cartridge) 20 and the changed flag state is written into the second memory 23 of the consumables unit (toner cartridge) 20.

However, when no flag in the first state (1) is found in the second memory 23, the procedure proceeds to step S9 and prompts the user to replace the consumables unit (toner cartridge) 20 with new one.

On the other hand, when the toner density is higher than the predetermined threshold value (step S4/NO), image forming is executed (step S7). When the processing is not finished (step S8/NO), the procedure returns to step S4.

The prevention of the falsification of the working life of a consumables unit (toner cartridge) will be described.

When some person desires to set the working life of the consumables unit (toner cartridge) to be longer, the person has to modify the first memory 22 and the second memory 23.

However, as to the second memory 23, the state of each of the flags can be changed only in the direction from the first state (1) to the second state (0) and, therefore, modification of the second memory 23 is in a direction that the working life is reduced. Therefore, no advantage is obtained with this modification.

The first memory 22 can be modified. However, the advantage of the falsification is reduced by setting the maximal number that the first memory 22 can express to be, for example, a number that substantially corresponds to the time necessary for executing toner supply once from the toner cartridge to the developing tank. Therefore, the falsification is able to be substantially prevented.

According to the above configuration, compared to the conventional method, it is advantaged that it is not necessary to determine whether these memories are falsified when the apparatus is started up, because the first memory and the second memory are separately managed.

The first memory only has to secure a memory for the least necessary data width (that is one byte in the embodiment) and, therefore, another advantage is obtained that the cartridge can be manufactured at low cost.

The present invention is similarly applicable to printing paper sheets in addition to a toner cartridge as the consumables unit. In this case, the stored value of the first memory is increased every time a paper sheet is supplied from a sheet cassette, and when the stored value of the first memory exceeds the maximal number that the first memory can express, the state of any one flag in the first state of the second memory only has to be changed to the second state.

The present invention is not limited to the above embodiment and various modifications and alterations may surely be made to the present invention within the range that does not extend from the scope of the present invention.

According to the present invention, the following effect is obtained.

According to the present invention, with a memory having a small capacity that is included in a replaceable unit used in an image forming apparatus, falsification of the life of the unit can be prevented.

1. An image forming apparatus that forms an image using a unit attached thereto and that detects the working life of the unit attached thereto, wherein
the unit comprises:
a first memory that has a data width capable of storing the consumed amount of the unit; and
a second memory that has a plurality of flags, each of the flags being capable of representing one of a first state and a second state, the first state being changeable to the second state while the second state is not changeable to the first state, and wherein
the image forming apparatus comprises:
a state changing portion that counts upward a stored value of the first memory associated with use of the unit, the state changing portion, when the stored value of the first memory exceeds a maximal value, initializing the first memory and changing the state of any one flag in the first state of the second memory to the second state; and
a signaling portion that determines and signals the working life of the unit based on the stored value of the second memory.

2. The image forming apparatus as defined in claim 1, wherein
the unit is a toner cartridge.

3. The image forming apparatus as defined in claim 1, wherein
data that is increased according to the use of the unit is a toner supply amount supplied to a developing apparatus or the number of printed paper sheets of the image forming apparatus.
